(19) United States
(12) Patent Application Publication
(10) Pub. No.: US 2014/0055471 A1
(43) Pub. Date: Feb. 27, 2014

(54) METHOD FOR PROVIDING SCALABLE REMOTE SCREEN IMAGE AND APPARATUS THEREOF

(71) Applicant: Electronics and Telecommunications Research Institute, (US)

(72) Inventors: Il-Hong SHIN, Daejeon (KR); Chang-Woo YOON, Daejeon (KR); Won RYU, Daejeon (KR)

(73) Assignee: Electronics and Telecommunications Research Instit ute, Daejeon (KR)

(21) Appl. No.: 13/837,122

(22) Filed: Mar. 15, 2013

(30) Foreign Application Priority Data
Aug. 21, 2012 (KR) 10-2012-0091318

(51) Int. Cl. G06T 9/00

(52) U.S. Cl. CPC G06T 9/00
USPC 345/522

(57) ABSTRACT

An apparatus and a method for providing a scalable remote screen image are provided. The method for providing a scalable remote screen image includes separating a remote screen image into an image and a graphic command; compressing the separated image using a scalable video encoder; and transmitting the compressed image and the separated graphic command to a client terminal, separately.

### CROSS-REFERENCE TO RELATED APPLICATION

This application claims the benefit under 35 U.S.C. §119(a) of Korean Patent Application No. 10-2012-0091318, filed on Aug. 21, 2012, the entire disclosure of which is incorporated herein by reference for all purposes.

### BACKGROUND

1. Field

The following description relates to a media convergence-transmission technology, and, more specifically, a technology for compressing and transmitting a video.

2. Description of the Related Art

With development of communication technologies, media technologies are now widely utilized in ordinary people's lives. In particular, a lot of multimedia codec boasting a remarkable compression rate makes it convenient to receive videos. From Moving Picture Experts Group (MPEG), a video codec has evolved into an H. 264 codec and a scalable video codec. The H. 264 and the scalable video codec are expected to be the dominant video codec. Meanwhile, various audio codec are used, including MPEG Audio Layer-3 (MP3) and Advanced Audio Coding (AAC).

There are many methods for providing a remote screen image from a server to a terminal. Among them, methods based on a thin-client or a zero-client have garnered interest largely due to the development of cloud techniques and communication networks. When a terminal is used as a thin-zero client, it is responsible for simple computing while a server has to deal with complex computing. In particular, a Remote Desktop Protocol (RDP), and the like, transmits a graphic command, which is a Graphic Device Interface (GDI) command, to a terminal. Thus, in the case of using the RDP, a large amount of video data can be transmitted. In addition, as a thin-client is not able to properly transmit a bitmap image using the RDP, an input image and an output image may not be synchronized.

Using such a method for providing a remote screen image, a user transmits information about resolution of a client terminal to a server in advance and receives a screen image with a predetermined resolution. However, there are some limitations in using the method when the user is on the move or the client terminal is wireless-connected to the server. In addition, as a conventional method for providing a remote screen image focuses a single user, it has some drawbacks because each participant should receive multiple-participant S/W through a single session in the case when the user needs to receive the multi-participant software (S/W), such as education, business corporations (three-dimensional (3D) design) and video conferences.

### SUMMARY

The following description relates to a method and an apparatus for providing a screen image to a user using a scalable video codec technology and a Graphic Hybrid technology, each technology helping to reduce a user's dependency on a network environment.

In addition, the following description relates to a method and an apparatus enabling multiple users to share a single screen image transmitted from a server using a scalable video codec to thereby avoid server loads led by multi-participant S/W and overcome constraints, such as a resolution of a client terminal.

In one general aspect of the present invention, a method for providing a screen image to a client terminal in a server is provided, and the method includes separating a remote screen image into an image and a graphic command; compressing the separated image using a scalable video encoder; and transmitting the compressed image and the separated graphic command to a client terminal.

The separating of the remote screen image may include analyzing a Graphic Device Interface (GDI) command which configures the remote screen image, and separating the GDI command into a bitmap image command and the graphic command based on an analysis result.

The analyzing of the GDI command may include acquiring the GDI command by analyzing a remote desktop protocol (RDP) packet.

The analyzing of the GDI command may include acquiring the GDI command using an Application Programming Interface (API) hooking scheme.

The compressing of the separated image may include compressing the separated image using the scalable video encoder to have a variable resolution whereby the client terminal is able to receive an image optimized for an access environment thereof.

The method may further include storing the compressed image in an image storage area; and storing the separated graphic command in a command queue, wherein the transmitting of the compressed image and the separated graphic command comprises transmitting the compressed image and the separated graphic command to the client terminal, separately.

The transmitting of the compressed image and the separated graphic command may include transmitting the separated graphic command along with a timestamp generated at a time when the client terminal begins assessing the server.

The transmitting of the compressed image and the separated graphic command comprises applying unequal error protection to the compressed image and the separated graphic command before transmission.

In another general aspect of the present invention, a method for receiving a remote screen image from a server in a client terminal is provided, and the method includes receiving a separated image and a separated graphic command separately by accessing a server; decoding the received image using a scalable video decoder; and reconfiguring a remote screen image by compositing the decoded image with the received graphic command.

The method may further include synchronizing the received graphic command with the decoded image, wherein the reconfiguring of the remote screen image comprises, if the received graphic command is sync with the decoded image, converting the received graphic command into a command corresponding to a graphic processor of the client terminal and then compositing the decoded image with the converted graphic command.

The method may further include scaling the decoded image using a scaler, wherein, the reconfiguring of the remote screen image comprises compositing the scaled image with the received graphic command.

The scaling of the decoded image may include scaling the decoded image with a low resolution to have an original resolution whereby the decoded image is able to correspond to coordinates and a size of the received graphic command.

The method may further include scaling the graphic command using a scaler, wherein the reconfiguring of the remote screen image comprises compositing the decoded image with the scaled graphic command.

The scaling of the graphic command may include scaling the graphic command to have coordinates satisfying ntx=txxx1/xh and a size satisfying nty=tyxy1/yh, in the case when the graphic command is a text command under the conditions that an original image transmitted by the server has a resolution of xh,yh, the client terminal has a resolution of x1,y1, and coordinates of the text command are tx,ty.

In another general aspect of the present invention, a server includes a command analyzing unit configured to analyze a GDI command which configures a remote screen image to thereby separate the screen image into a image and a graphic command; a scalable video encoder configured to compress the separated image; and a transmitting unit configured to transmit the compressed image and the separated graphic command to a client terminal, separately.

The scalable video encoder may compress the separated image to have a variable resolution whereby the client terminal is able to receive an image optimized for an assessing environment thereof.

The server may further include an error protection unit configured to apply unequal error protection to the compressed image and the separated graphic command.

The server may further include a multiple user-input processing unit configured to process user inputs of a plurality of user terminals whereby the plurality of user terminals are able to share and control the remote screen image.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a scalable video encoder adapted in the present invention;

FIG. 2 is a diagram illustrating a system for providing a remote screen image according to an exemplary embodiment of the present invention;

FIG. 3 is a diagram illustrating a remote screen image which is remotely provided using a method that is suggested in the present invention;

FIG. 4 is a configuration of a server according to an exemplary embodiment of the present invention;

FIG. 5 is a reference diagram illustrating a method for analyzing a command and storing memory in a server according to an exemplary embodiment of the present invention;

FIG. 6 is a diagram illustrating a configuration of a client terminal according to an exemplary embodiment of the present invention;

FIGS. 7 and 8 are diagrams examples of a screen image in a client terminal on various communication networks according to various exemplary embodiments of the present invention.

FIG. 9 is a reference diagram illustrating an example of remotely providing a remote screen image according to various accessing environments of different client terminals according to an exemplary embodiment of the present invention;

FIG. 10 is a flow chart illustrating a method for remotely providing a remote screen image in a server according to an exemplary embodiment of the present invention; and

FIG. 11 is a flow chart illustrating a method for receiving a screen image in a client terminal according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

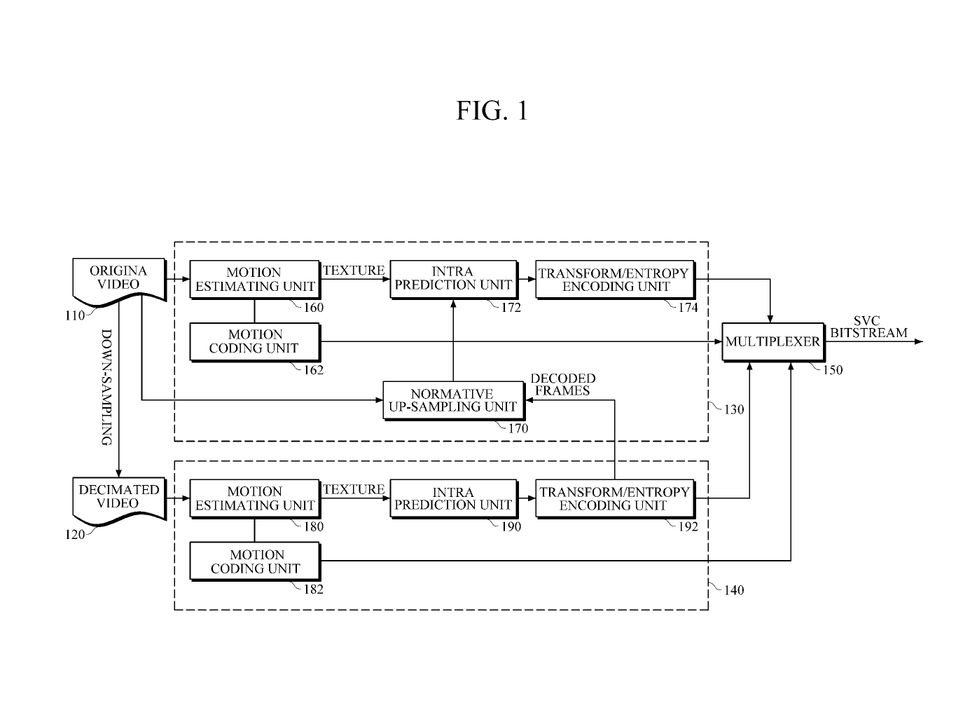

FIG. 1 is a diagram illustrating a configuration of a scalable video encoder adapted in the present invention.

Referring to FIG. 1, a scalable video encoder receives an original video 110 and a decimated video 120, and includes an upper layer encoder 130, a lower (base) layer encoder 140 and a multiplexer 150.

The decimated video 120 is a result of down-sampling the original video 110. That is, the decimated video 120 generally has a low resolution and less Frames Per Second (fps), compared to the original video 110.

The upper layer encoder 130 includes a motion estimating unit 160, a motion coding unit 162, a normative up-sampling unit 170, an intra prediction unit 172 and a transform/entropy encoding unit 174. The lower layer encoder 140 includes a motion estimating unit 180, a motion coding unit 182, an intra prediction unit 190 and a transform/entropy encoding unit 192.

The following is a description of the elements of the lower layer encoder 140. The motion estimating unit 180 estimates a motion of the decimated video 120. The estimated motion is encoded by the motion coding unit 182. Texture output from the motion estimating unit 180 is transmitted to the intra prediction unit 190, and the intra prediction unit 190 performs an intra prediction for the texture. Then, the transform/entropy encoding unit 192 transforms and/or entropy encodes the result of the intra prediction.

The following is a description of the elements of the upper layer encoder 130. The motion estimating unit 160 estimates the motion of the original video 110. The estimated motion is encoded by the motion coding unit 162. The normative up-sampling unit 170 performs normative-up-sampling on decoded frames or the decoded original video 110 received from the transform/entropy encoding unit 192. The intra prediction unit 172 performs intra-prediction for the texture from the motion estimating unit 180 or for the up-sampled frames from the normative-up-sampling unit 170. The transform/entropy encoding unit 174 transforms and/or entropy-encodes the result of the intra prediction.

The multiplexer 150 performs multiplexing on an image which has been coded in the motion coding unit 162, the transform/entropy encoding unit 174, the motion coding unit 182 or the transform/entropy encoding unit 192 to thereby output a Scalable Video Coding (SVC) bitstream.

Using the scalable video coding method, a video signal may be encoded with the highest resolution. Even if only a part of the resultant picture sequence of the encoded video signal (that is, intermittent frames in the sequence) is decoded, a corresponding video may be displayed despite a low resolution. However, it is difficult to encode a text to be displayed on a computer screen using the scalable coding method.

For example, if a video is to be decimated as shown in FIG. 1, a low-pass filter is required, and the use of the low-pass filter deteriorates the quality of the video. At this time, if a low filter filers a text, the quality of the text may be deteriorated. It is easy to notice a deteriorated quality of a video on a computer screen, unlike on a general TV video screen. In addition, the quality of a graphic command, such as a rectangle command and an ellipse command, may be also deteriorated when being filtered by a low pass filter. However, a user may not notice a significant change in the quality of a bitmap image, such as a video or a picture, which has been filtered by the low pass filter. For this reason, the present invention proposes a method for remotely providing a remote screen image to a user by separating the remote screen image into an image and a graphic command, compressing the separated image using a scalable video encoder, and then transmitting the compressed image and the graphic command.

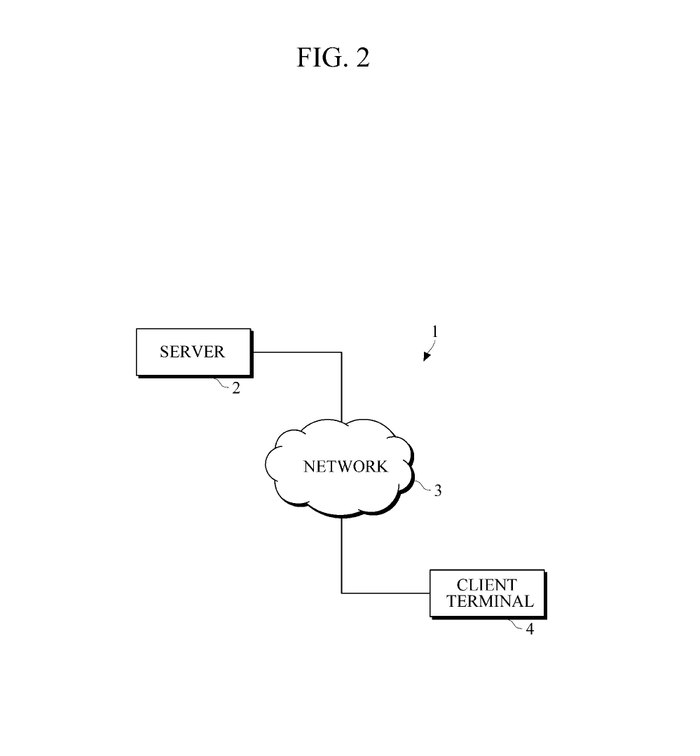

FIG. 2 is a diagram illustrating a configuration of a system 1 for remotely providing a remote screen image according to an exemplary embodiment of the present invention.

Referring to FIG. 2, the system 1 for remotely providing a remote screen image includes a server 2, a network 3 and a client terminal 4.

In the system 1 for remotely providing a remote screen image, the client terminal 4 is configured to be as simple as possible, and information and functions that an ordinary client terminal 4 does are assumed by the server 2. At this time, the server 2 executes an application program installed therein, and remotely provides an execution result to the client terminal 4 via the network 3. In addition, a plurality of client terminals 4 may be provided.

The present invention relates to a technique for remotely providing a remote screen image to a user of the client terminal 4 using a scalable video codec and a graphic hybrid technology so as to reduce dependency of the client terminal 4 on a network when a screen image is remotely provided from the server 2 to the client 4.

That is, in order to remotely provide a remote screen image to the client terminal 4, the server 2 has to separate the remote screen display into an image and a graphic command, encode the image using a scalable video encoder, and transmit the encoded image and the graphic command to the client terminal 4. The client terminal 4 accessing the server 2 receives the encoded image and the graphic command. Then, the server 2 decodes the received image using a scalable video decoder, reconfigures the screen image by compositing the decoded image with the graphic command, and displays the reconfigured screen image for a user.

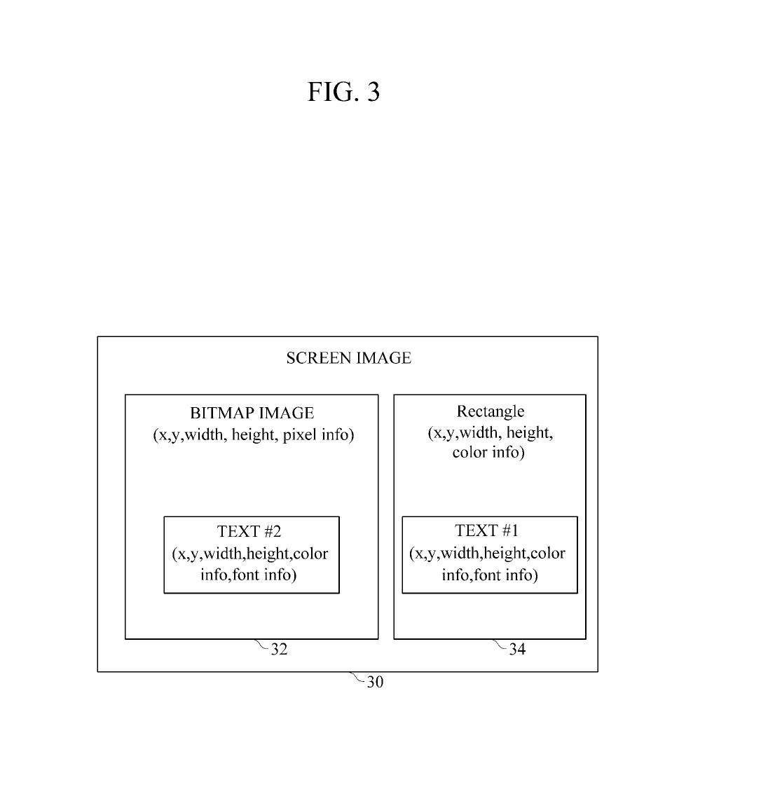

FIG. 3 is a diagram illustrating an image where the present invention is employed.

Referring to FIG. 3, the screen image 30, for example, an image displayed on a computer screen, is composed of an image 32 and a graphic command 34. The image 32 may be a bitmap image, and includes photo or video. In addition, the image 32 includes related information, such as coordinates (x,y), a size (width, height), and pixels. The graphic command 34 means a text command or a diagram command, such as a rectangle and an ellipse. The graphic command 34 includes related information, such as coordinates, size (width and height), font and color, required by an Operating System (OS).

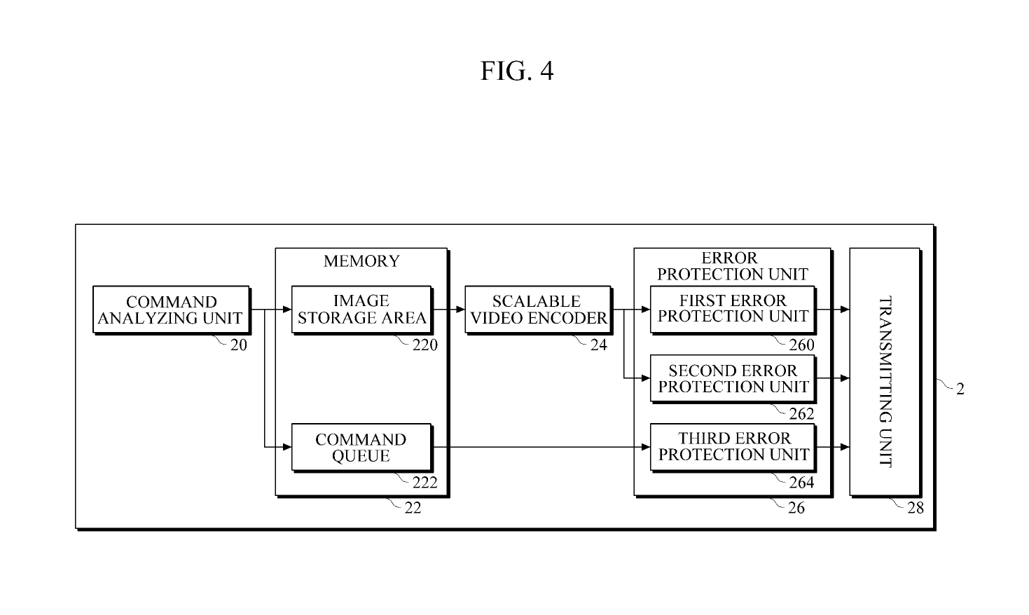

FIG. 4 is a diagram illustrating a configuration of a server 2 according to an exemplary embodiment of the present invention.

Referring to FIGS. 2 and 4, the server 2 includes a command analyzing unit 20, a memory 22, a scalable video encoder 24, an error protecting unit 26 and a transmitting unit 28.

The command analyzing unit 20 analyzes a Graphic Device Interface (GDI) command, which configures a remote screen image, and separates the remote screen image into an image command and a graphic command. The command analyzing unit 20 may obtain a GDI command by analyzing a Remote Desktop Protocol (RDP) packet, and separate the remote screen image into the image command and the graphic command by analyzing the GDI command. Alternatively, the command analyzing unit 20 may analyze the GDI command by obtaining the GDI command using an Application Programming Interface (API) hooking scheme.

The memory 22 stores the image and the graphic command separately. According to an exemplary embodiment of the present invention, the image is stored in an image storage area 220 and the graphic command is stored in a command queue 222.

The scalable video encoder 24 compresses the image which is separated in the command analyzing unit 20. For example, the scalable video encoder 24 compresses an image into a bit stream of high resolution and a non-stream of low resolution. The image is able to be compressed into every format, such as jpeg and mpeg.

As the scalable video encoder 24 compresses the image to have variable resolution, the client terminal 4 is able to receive an image optimized for an access environment thereof. In other words, even in the case of moving or being connected to a wireless communication network, the client terminal 4 may remotely receive a remote screen image suitable for the current access environment thereof using the scalable video encoder 24.

The error protection unit 26 applies unequal error protection to an image command and a graphic command. A graphic command generally requires a lesser amount of data to be transmitted compared to an image command, so that various error protection methods may be employed. According to an exemplary embodiment of the present invention, a third error protection unit 264 applies strong error protection to a graphic command. Meanwhile, an image command is applied with lower error protection than that of the graphic command. Specifically, a first error protection unit 260 applies moderate error protection to a low-resolution bit stream which is compressed in the scalable video encoder 24, while a second error protection unit 262 applies low error protection to a high-resolution bit stream. In this way, a user is able to stably receive a graphic command, such as text information with improved efficiency in information exchange.

The transmitting unit 28 transmits the image command and the graphic command to the client terminal 4, separately. According to an exemplary embodiment of the present invention, the transmitting unit 28 may transmit the graphic command along with a timestamp which is generated at a time when the client terminal 4 accesses the server 2.

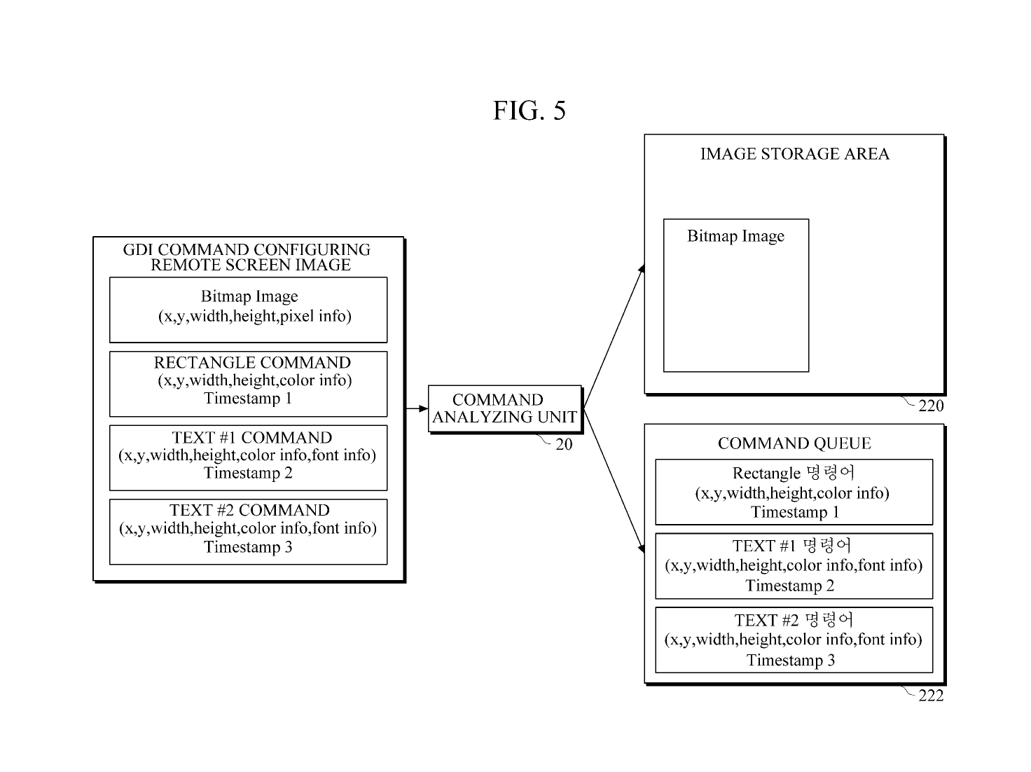

FIG. 5 is a reference diagram illustrating a method for analyzing a command and storing memory in the server 2 according to an exemplary embodiment of the present invention.

Referring to FIGS. 4 and 5, a command analyzing unit 20 analyzes a graphic command of a GDI command which configures a screen image. That is, when the remote screen image is separated into an image and a graphic command, a bitmap image is stored in an image storage area 220 of a memory while a graphic command, such as a text command, a rectangle command and an ellipse command, is stored in the command queue 222 of the memory. The graphic command may be stored along with a timestamp. A timestamp indicates how long the client terminal 4 has been accessing the server 4, and is counted from “0.”

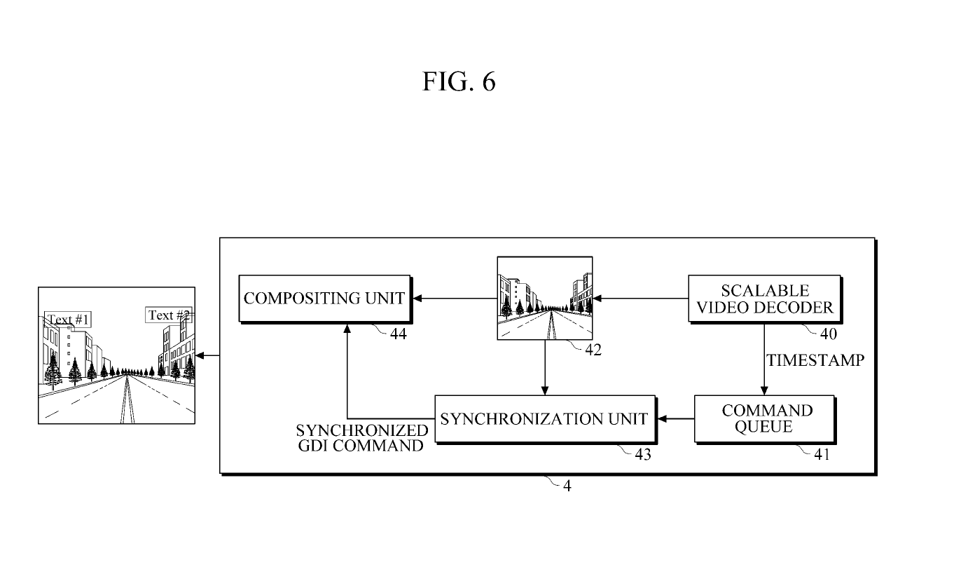

FIG. 6 is a diagram illustrating a configuration of a client terminal 4 according to an exemplary embodiment of the present invention.

Referring to FIG. 6, the client terminal 4 includes a scalable video decoder 40, a command queue 41, a synchronizing unit 43 and a compositing unit 44.

The scalable video decoder 40 receives an image and a graphic command from a server 2, separately, and decodes the received image. For instance, if a jpeg image is encoded in the server 2, the scalable video decoder 40 decodes the encoded jpeg image. In addition, the graphic command received from the server 2 may be stored in the command queue 41.

The synchronization unit 43 synchronizes the received graphic command with the decoded image. According to an exemplary embodiment of the present invention, the synchronization unit 43 synchronizes the graphic command with a refresh rate of the image decoded in the scalable video according to the timestamp received along with the graphic command from the server 2.

The compositing unit 44 reconfigures a screen image by compositing the decoded image and the graphic command. As a result, a user is able to see the reconfigured screen image displayed. According to an exemplary embodiment of the present invention, the compositing unit 44 converts a graphic command, which has been synchronized in the synchronization unit 43, into a command corresponding to a graphic processor of the client terminal 4, and then composites the decoded image with the converted graphic command.

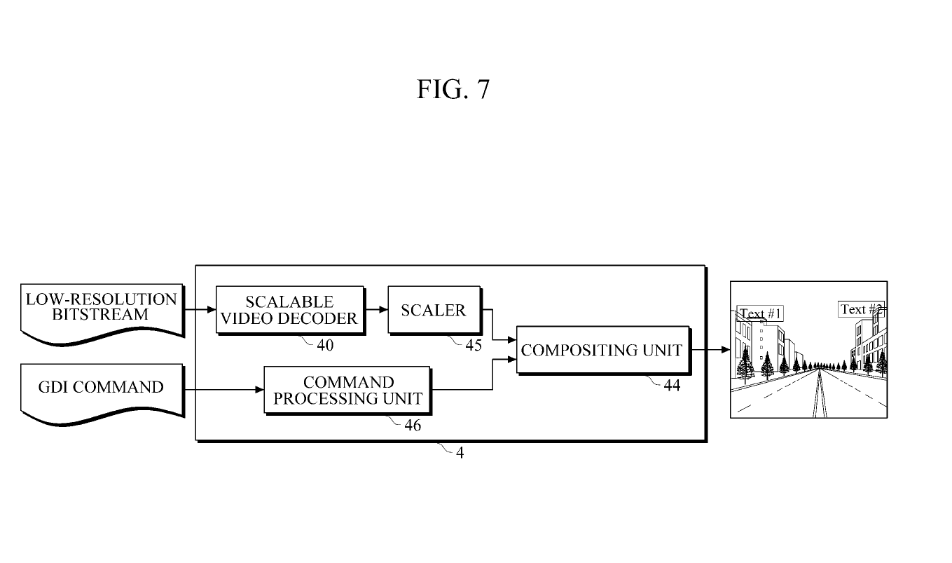

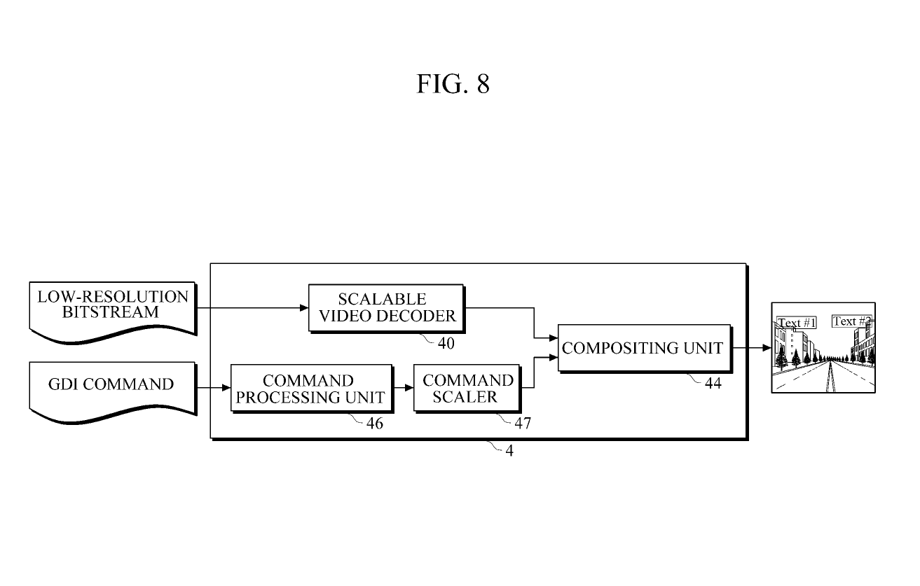

FIGS. 7 and 8 are reference diagrams illustrating examples of a remote screen image which is remotely provided to a client terminal 4 on various networks.

A user is able to see a remote screen image with the highest predetermined resolution in the client terminal 4 using a scalable video codec, only when the screen image is transmitted at a stable speed on a wired network. However, if the communication status is unstable or the client terminal 4 is connected to a wireless network, a great loss of packets may occur, and the client terminal 4 may receive a lesser amount of low-resolution video packets. At this time, the client terminal 4 receives the graphic command generated to correspond to an original image with the highest resolution, so the graphic command needs to be scaled to be suitable for the resolution of a transmitted image. Hereinafter, a scaling method is provided with reference to FIGS. 7 and 8 according to various exemplary embodiments of the present invention.

According to an exemplary embodiment of the present invention, as illustrated in FIG. 7, a scaler 45 scales an image decoded by a scalable video decoder 40. That is, the scaler 45 scales an image decoded at a low resolution to be the original resolution. Specifically, the scaler 45 helps the image decoded at a low resolution in the scalable video decoder 40 to correspond to the coordinates and size of the graphic command. In this case, the compositing unit 44 reconfigures a screen image by compositing the image, which is scaled by the scaler 45, and the graphic command, which is processed by a command processing unit 46.

According to another exemplary embodiment of the present invention, a command scaler 47 scales a graphic command, as illustrated in FIG. 8. For example, the command scaler 47 scales a graphic command to have coordinates satisfying ntx=txxx1/xh and a size satisfying nty=tyxy1/yh, in the case when the graphic command is a text under the conditions that an original image transmitted by the server 2 has a resolution of xh,yh, that the client terminal 4 has a resolution of x1,y1, and that coordinates of the text command are tx,ty. The above method may be employed when a resolution of the client terminal 4 accessing the server 2 to remotely receive a remote screen image has changed. In such a case, the compositing unit 44 reconfigures the screen image by compositing the decoded image with the graphic command that is scaled by the command scaler 47.

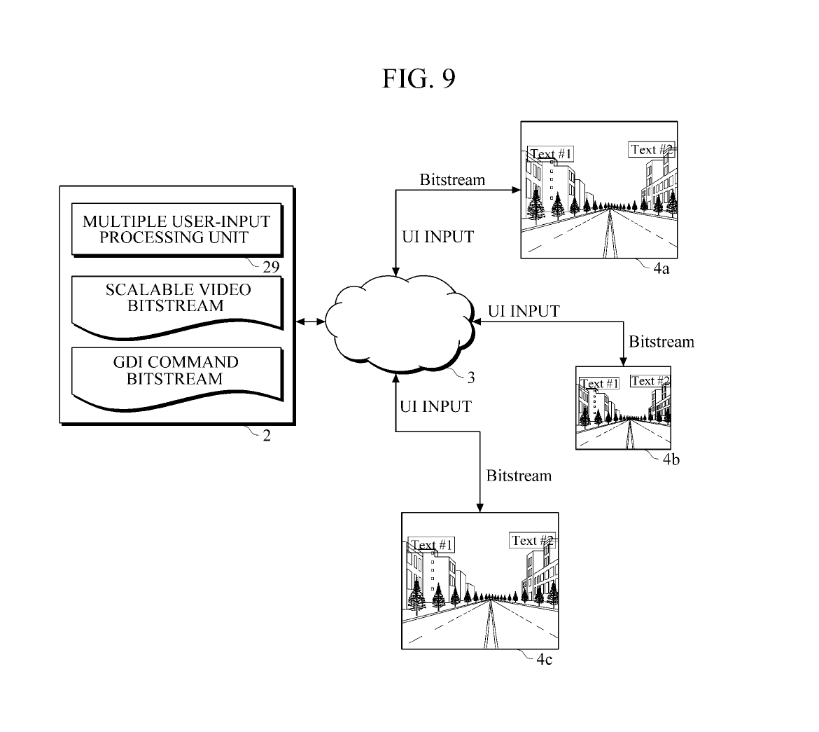

FIG. 9 is a reference diagram illustrating an example of remotely providing a remote screen image according to various access environments of different client terminals according to an exemplary embodiment of the present invention.

Referring to FIG. 9, a user is able to remotely receive a remote screen image by accessing a server 2 using various client terminals 4 of different various access environments. For instance, the user may access the server 2 using a client terminal 4a while on the move. Alternatively, the user is able to access the server 2 using a low-resolution client terminal 4b or a high-resolution client terminal 4c.

The scalable video codec method and the graphic command transmitting method proposed in the present invention enables multiple users to share and watch a single remote screen image that is remotely provided from the server 2. In addition, the server 2 includes a multiple user-input processing unit 29 to help multiple users to control a single screen image.

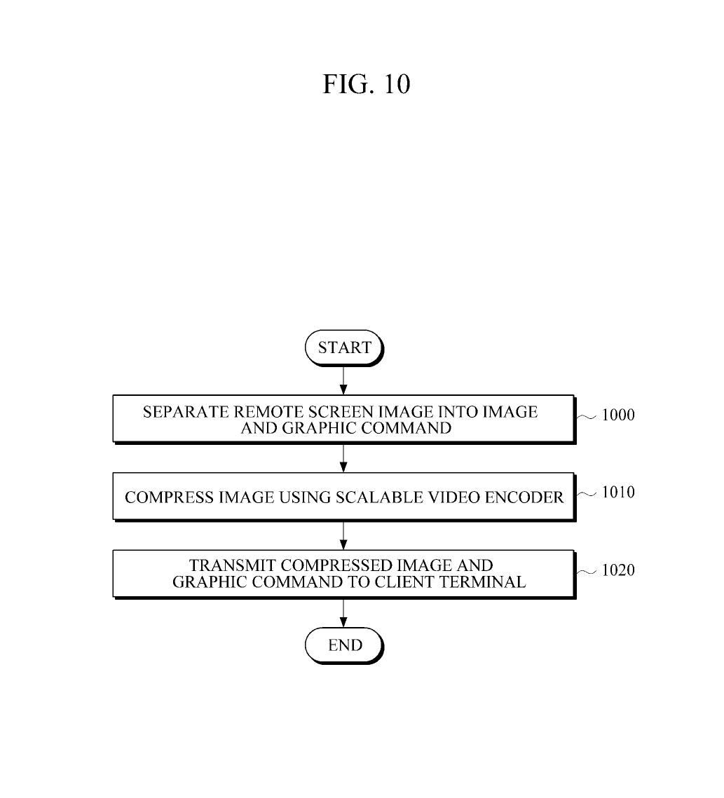

FIG. 10 is a flow chart illustrating a method for remotely providing a remote screen image in a server 2 according to an exemplary embodiment of the present invention.

Referring to FIGS. 2 and 10, a server 2 separates a remote screen image into an image and a graphic command in operation 1000. In operation 1000, the server 2 analyzes a GDI command composing the screen image, and separates the GDI command into a bitmap image and a graphic command using the analysis result.

Next, the server 2 compresses the separated image using a scalable video encoder in operation 1010. In operation 1010, the server 2 compresses the image using the scalable video encoder to have a variable resolution, so that the client terminal 4 may receive an image optimized for an access environment thereof.

Next, the compressed image and separated graphic command are transmitted to the client terminal 4 in operation 1020. In operation 1020, the server 2 may transmit the separated graphic command along with a timestamp generated at a time when the client terminal 4 begins accessing the server 2. Furthermore, in operation 1020, the server 2 may apply unequal error protection to the compressed image and the separated graphic command, respectively, and transmit to the client terminal 4 the compressed image and the separated graphic command, each applied with a different error protection.

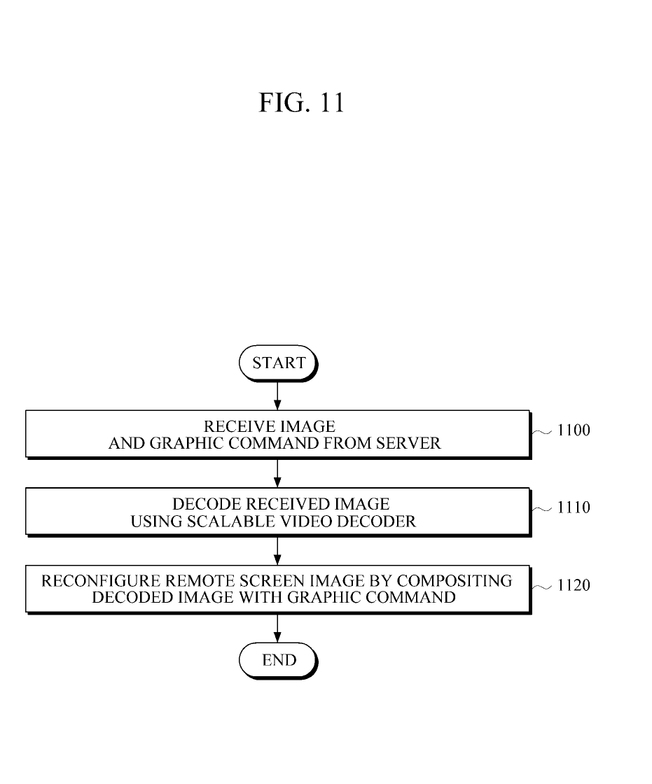

FIG. 11 is a flow chart illustrating a method for remotely receiving a remote screen image in a client terminal 4 according to an exemplary embodiment of the present invention.

Referring to FIGS. 2 and 11, the client terminal 4 receives a separated image and a separated graphic command, respectively, by accessing a server 2 in operation 110, and then decodes the received image using a scalable video decoder in operation 1110. Next, the client terminal 4 reconfigures a screen image by compositing the decoded image with the received graphic command in operation 1120, and then displays the reconfigured screen image for a user.

After the decoding process, a process for synchronizing the decoded image with the received graphic command may be further included. Specifically, in operation 1120, the client terminal 4 may convert the graphic command into a command corresponding to a graphic processor of the client terminal 4 when the image and the graphic command is completely synchronized, and then may composite the decoded image with the converted graphic command.

According to an exemplary embodiment of the present invention, the client terminal 4 scales the image decoded by the scalable video decoder using a scaler. In addition, in operation 1120, a remote screen image is reconfigured by compositing the scaled image with the graphic command. According to another exemplary embodiment of the present invention, the client terminal 4 scales the graphic command using the scaler, and then, in operation 1120, reconfigures the remote screen image by compositing the decoded image with the scaled graphic command.

According to an exemplary embodiment of the present invention, a user of a client terminal may remotely receive a remote screen image conveniently from a server when the client terminal accesses the server. That is, it is able to remotely provide a remote screen image optimized for the user's access environment using a scalable video codec and a graphic hybrid technology.

Furthermore, the scalable video codec enables multiple users to share a single remote screen image remotely provided from the server. In this way, the heavy loads on the server may be prevented and the screen image may be displayed with resolution adequate for each client terminal.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for providing a remote screen image to a client terminal in a server, the method comprising:
separating a remote screen image into an image and a graphic command;
compressing the separated image using a scalable video encoder; and
transmitting the compressed image and the separated graphic command to a client terminal.

2. The method of claim 1, wherein the separating of the remote screen image comprises analyzing a Graphic Device Interface (GDI) command which configures the remote screen image, and separating the GDI command into a bitmap image command and the graphic command based on an analysis result.

3. The method of claim 2, wherein the analyzing of the GDI command comprises acquiring the GDI command by analyzing a remote desktop protocol (RDP) packet.

4. The method of claim 2, wherein the analyzing of the GDI command comprises acquiring the GDI command using an Application Programming Interface (API) hooking scheme.

5. The method of claim 1, wherein the compressing of the separated image comprises compressing the separated image using the scalable video encoder to have a variable resolution whereby the client terminal is able to receive an image optimized for an access environment thereof.

6. The method of claim 1, further comprising:
storing the compressed image in an image storage area; and
storing the separated graphic command in a command queue,
wherein the transmitting of the compressed image and the separated graphic command comprises transmitting the compressed image and the separated graphic command to the client terminal, separately.

7. The method of claim 1, wherein the transmitting of the compressed image and the separated graphic command comprises transmitting the separated graphic command along with a timestamp generated at a time when the client terminal begins assessing the server.

8. The method of claim 1, wherein the transmitting of the compressed image and the separated graphic command comprises applying unequal error protection to the compressed image and the separated graphic command before transmission.

9. A method for receiving a remote screen image from a server in a client terminal, the method comprising:
receiving a separated image and a separated graphic command by accessing a server;
decoding the received image using a scalable video decoder; and
reconfiguring a remote screen image by compositing the decoded image with the received graphic command.

10. The method of claim 9, further comprising:
synchronizing the received graphic command with the decoded image,
wherein the reconfiguring of the remote screen image comprises, if the received graphic command is sync with the decoded image, converting the received graphic command into a command corresponding to a graphic processor of the client terminal and then compositing the decoded image with the converted graphic command.

11. The method of claim 9, further comprising:
scaling the decoded image using a scaler,
wherein the reconfiguring of the remote screen image comprises compositing the scaled image with the received graphic command.

12. The method of claim 11, wherein the scaling of the decoded image comprises scaling the decoded image with a low resolution to have an original resolution whereby the decoded image is able to correspond to coordinates and a size of the received graphic command.

13. The method of claim 9, further comprising:
scaling the graphic command using a scaler,
wherein the reconfiguring of the remote screen image comprises compositing the decoded image with the scaled graphic command.

14. The method of claim 13, wherein the scaling of the graphic command comprises scaling the graphic command to have coordinates satisfying ntx=txxx1/xh and a size satisfying nty=tyxy1/yh, in the case when the graphic command is a text command under the conditions that an original image transmitted by the server has a resolution of xh,yh, the client terminal has a resolution of x1,y1, and coordinates of the text command are tx,ty.

15. A server comprising:
a command analyzing unit configured to analyze a GDI command, which configures a remote screen image, to thereby separate the remote screen image into a image and a graphic command;
a scalable video encoder configured to compress the separated image; and
a transmitting unit configured to transmit the compressed image and the separated graphic command to a client terminal, separately.

16. The server of claim 15, wherein the scalable video encoder compresses the separated image to have a variable resolution whereby the client terminal is able to receive an image optimized for an assessing environment thereof.

17. The server of claim 15, further comprising:
an error protection unit configured to apply unequal error protection to the compressed image and the separated graphic command.

18. The server of claim 15, further comprising:
a multiple user-input processing unit configured to process user inputs of a plurality of user terminals whereby the plurality of user terminals are able to share and control the remote screen image.
